(19) United States
(12) Patent Application Publication
(10) Pub. No.: US 2026/0307111 A1
(43) Pub. Date: Oct. 8, 2026

(54) CLEANER/CONDITIONER FOR FLYLINE

(71) Applicant: Curtis S. King, Bozeman, MT (US)

(72) Inventor: Curtis S. King, Bozeman, MT (US)

(21) Appl. No.: 19/170,925

(22) Filed: Apr. 4, 2025

(51) Int. Cl. B08B 1/20; A01K 97/00; B08B 1/40

(52) U.S. Cl. CPC B08B 1/20; A01K 97/00; B08B 1/40

(57) ABSTRACT

A device to clean and/or condition a line. A device includes a body with internal material that is capable of holding a quantity of fluid for spreading that fluid onto a length of the line. An axially disposed line access port includes a slot extending from a body exterior surface inwardly toward a body center. The slot permits transverse installation of the line conditioner onto a length of line that is installed on a fishing pole. Body material may be biased to urge an opened slot toward a closed configuration. A body may be shaped as desired, including spherical, pointy at both poles, or pointy at one pole and spherical at the other pole. An exterior surface of the body may be configured to augment an anchor with respect to the fishing pole. An anchor may include one or more groove, or simply “squishy” body material.

### RELATED APPLICATIONS

This application claims the benefit under 35 U.S.C. 119(e) of the filing dates of U.S. Provisional Application Serial No. 63/574,775, filed Apr. 4, 2024, for “CLEANER FOR FLYLINE”; U.S. Design Application Ser. No. 29/952,568, filed Jul. 16, 2024, for “LINE CLEANER”; and U.S. Design application Ser. No. 29/952,582, filed Jul. 16, 2024, for “LINE CLEANER WITH PLURAL GROOVES”, the entire disclosures of which are incorporated herein by this reference.

### BACKGROUND

### Field of the Invention

This invention relates to devices for cleaning and/or conditioning sporting goods products. A preferred embodiment is configured for cleaning and/or conditioning a flyline used in the sport of fly fishing.

### Background

Fly fishing lines are composite structures comprised of an internal cable element of typically either mono-or multi-filament construction, where this cable element is fully extruded (“encased”) within a polymer jacket/coating. The internal cable/filament may be polymer, or metal, or a combination thereof. The outer jacket/coating is typically a polymer compound, types often include polyvinyl chloride (PVC), fluoropolymer (PTFE, FEP), polyamide (nylon), or a variety of other polymers.

In use, the outer coating of the fly line is often damaged. The damage may be mechanical in nature, such as that caused by abrasion, or cutting, or excess stress induced on the line. Damage is also often related to chemical exposure (oils from hands, exposure to solvents, or other), or UV light exposure, both of which degrade the polymer jacket, often causing it to become brittle, resulting in cracking or other damage to the outer covering of the line, especially when combined with the mechanical stresses the line is exposed to in use.

Consumer products such as disposable wipes, and liquids exist on the market currently that are intended to be used in cleaning, lubricating, or otherwise protecting the outer jacket of the line. These products are effective but can be difficult to use. In the case of a wipe-style product, the entirety of the line must be pulled through the wipe. Any debris or contaminant on the line is picked up by the wipe. If the user does not frequently change the point of contact between the wipe and the line, the contaminant can be spread across the line, resulting in a less than effective cleaning. Also, to use any of these products it is necessary to 1) remove the entirety of the line from its spool, and then 2) dress the line by feeding the line through the wipe product, and then 3) re-spooling the line. If one were to attempt this line dressing procedure using this method/product, in the field, the line could be easily contaminated in the process. There exists a need in the art for a simplified means of consistently applying protective, cleaning, or lubricating compounds to the polymer coating of a commercial fly line to help protect and preserve the mechanical integrity of the line jacket/coating.

### BRIEF SUMMARY OF THE INVENTION

This invention provides a line conditioner to treat a line that is passed in a line length direction through the line conditioner. An embodiment includes a body with a line access port. A workable body includes internally disposed body material capable of holding a quantity of fluid for dispensing the fluid onto a desired surface by way of contact between the body material and the surface. A workable line access port is configured to permit transverse installation of the body in operable engagement with a line to dispose a surface of the line in contact with the internally disposed body material.

A line access port may include a slot extending transversely inward from an opening disposed at a body exterior surface. An exemplary line access port includes a slot extending transversely inward from a body surface to terminate in proximity to a body centerline. Sometimes, the line access port may include a slot extending transversely inward from a body surface by a distance greater than, or less than, half a body thickness. In some cases, a bottom termination of a slot may be generally parallel to a body length axis.

In certain cases, an aperture may be disposed at a bottom termination of the slot. An aperture may define a path extending through the body in a length direction from a first pole end to an opposite pole end of the body.

Desirably, a slot is biased by the body toward a normally-closed position. A slot may be biased by the body away from an open position in which the opening of the slot encompasses more than about ten degrees about a body centerline.

An exterior surface of the body may define a generally spheroid shape. A preferred embodiment has an exterior body surface that defines a generally prolate spheroid shape. One workable exterior surface of a body defines a prolate spheroid shape at one pole end and a generally spheroid shape at an opposite pole end. A workable body shape may be characterized as an object defined by revolution of a curved line segment about a central body length axis.

Desirably, the line conditioner is configured to grip a line to hold the weight of the line conditioner for hands-free use subsequent to disposing the line in the slot. In some cases, the exterior surface may include a groove, or other configuration of structure, to augment an anchor with a portion of a fishing rod. For non-limiting example, a portion of the exterior surface may be configured to engage within a ring provided by an eyelet of a fishing pole such that a structural interference between the body and the ring is operable to hold the body stationary with respect to the fishing pole while moving a length of line in a first direction along a path through the body. The body may be configured such that the interference is operable to also permit moving the line in a second direction reversed from the first direction. The body may be configured such that insertion of the body into engagement with the eyelet enhances a compression force between the body and a length of line disposed inside the body.

An embodiment may be arranged for commercial sale. In one case, a line conditioner may be installed inside a waterproof envelope. A line conditioner may be sealed inside the envelope with the body material being in a wetted condition by treatment fluid.

The invention may be embodied in a method. One such method includes providing a line conditioner having a body with internally disposed body material capable of holding a quantity of fluid for dispensing the fluid onto a desired surface by way of contact between the body material and the surface, and an axially oriented slot extending transversely inward from a body surface to terminate in parallel with a body centerline. A method may further include instructing a user to install the body on a flyline by transversely sliding an axial portion of the flyline into engagement inside the slot such that the body is disposed in proximity to an eyelet of a fishing pole, and an interface formed between the slot and flyline is effective to resist decoupling the body from the flyline under weight of the installed body. A method may further include instructing a user to pass an extended length of the flyline in a first length direction through the body while the body applies fluid to, and exerts a compression force on, an exterior surface of the flyline. A method may further include instructing the user to pass the flyline in a second length direction through the body without adjusting registration of the line conditioner with respect to the fishing pole, the second length direction being opposite to the first direction. Alternatively, the user may be instructed to adjust a position of the line cleaner with respect to the fishing pole in preparation for changing direction of line motion. A method may also include instructing the user to insert the body in partial penetration through the eyelet to engage the eyelet in registration inside a groove disposed in a surface of the body and thereby enhance compression of a portion of internally disposed body material against the flyline.

### BRIEF DESCRIPTION OF THE DRAWINGS

In the drawings, which illustrate what are currently considered to be the best modes for carrying out the invention:

FIG. 1 is a view in perspective of an embodiment constructed according to certain principles of the invention;

FIG. 2 is an end view in elevation of the embodiment in FIG. 1;

FIG. 3 is a side view in elevation of the embodiment in FIG. 1;

FIG. 4 is a view in perspective of another embodiment;

FIG. 5 is an end view in elevation of the embodiment in FIG. 4;

FIG. 6 is a side view in elevation of the embodiment in FIG. 4;

FIG. 7 is a view in perspective of another embodiment;

FIG. 8 is an end view in elevation of the embodiment in FIG. 7;

FIG. 9 is a side view in elevation of the embodiment in FIG. 7;

FIG. 10 is a view in perspective of another embodiment;

FIG. 11 is an end view in elevation of the embodiment in FIG. 10;

FIG. 12 is a side view in elevation of the embodiment in FIG. 10;

FIG. 13 is a view in perspective of another embodiment;

FIG. 14 is an end view in elevation of the embodiment in FIG. 13;

FIG. 15 is a side view in elevation of the embodiment in FIG. 13;

FIG. 16 is a view in perspective of an embodiment installed on a line;

FIG. 17 is a view in perspective of an embodiment installed on a line;

FIG. 18 is a view in perspective of an embodiment installed on a line;

FIG. 19 is a view in perspective of a fly fishing assembly;

FIG. 20 is that portion of the assembly in FIG. 19 indicated by circle 20;

FIG. 21 is that portion of the assembly in FIG. 20 indicated by circle 21;

FIG. 22 is a view similar to that in FIG. 21;

FIG. 23 is a view similar to that in FIG. 21;

FIG. 24 is a view in perspective from one end of an embodiment;

FIG. 25 is a view in perspective from the opposite end of the embodiment in FIG. 24;

FIG. 26 is a top view of the embodiment in FIG. 24;

FIG. 27 is a view in perspective from one end of an embodiment;

FIG. 28 is a view in perspective from the opposite end of the embodiment in FIG. 27; and

FIG. 29 is a top view of the embodiment in FIG. 27.

### DETAILED DESCRIPTION OF THE ILLUSTRATED EMBODIMENTS

Reference will now be made to the drawings in which the various elements of the illustrated embodiments will be given numerical designations and in which the invention will be discussed so as to enable one skilled in the art to make and use the invention. It is to be understood that the following description is only exemplary of certain principles of the present invention, and should not be viewed as narrowing the claims which follow.

An embodiment constructed according to certain principles of the instant invention may be characterized as a line conditioner. In general, a line conditioner applies a treatment (e.g., action and/or agent) to a line. A simple line cleaner is one embodiment of a line conditioner. A line cleaner may apply fluid, such as water or a diluted detergent, and desirably will impart a scrubbing effect to a line to remove dirt or undesired residue from a line surface. Another embodiment of a line conditioner may be adapted to apply a lubricant, surfactant, flotant, or other treatment substance to a line surface. Currently preferred embodiments are constructed to apply a line conditioning treatment of some sort to flylines used in the sport of fly fishing.

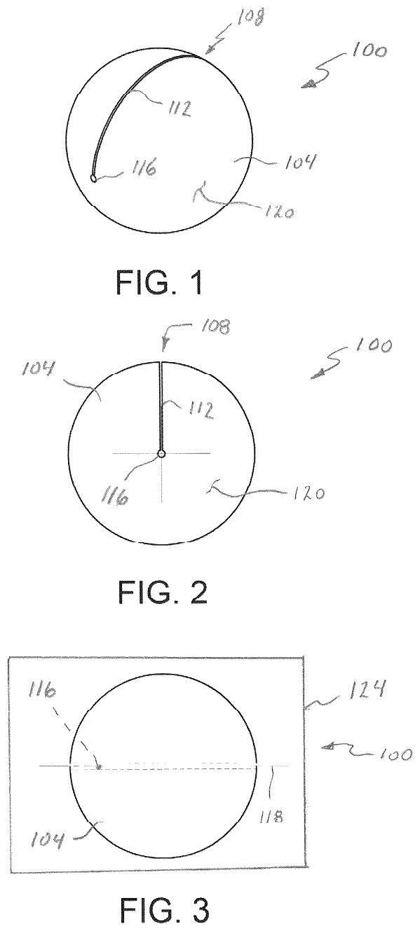

A first embodiment of a line conditioner constructed according to certain principles of the invention is indicated generally at 100 in FIGS. 1-3. Line conditioner 100 includes a compliant, or semi-compliant, 3-dimensional body 104. A workable body 104 may be fashioned from one or more materials such as a sponge, structural foam matrix of urethane, plastic, cork, cellulose, polymer, and the like. An exemplary workable body material includes material of composition of a foam makeup application tool sold under the name Beautyblender™.

For purpose of this disclosure, embodiments according to certain principles of the invention may be made reference to by numeral 100ⁱ, where i may be nothing, or, one or more primes. Each of such distinctly labeled embodiments includes substantial overlapping construction, but also may include one or more distinguishing element. In any case, like structure is indicated with like numerals.

Desirably, interior material of body 104 is capable of holding a fluid, and dispensing the fluid onto a desired surface by way of contact between the body material and the surface. A workable body 104 may therefore include, carry, or be embedded with a single chemical compound, or a multitude of chemical compounds. For example, a body 104 may include a material that contains an embedded chemical cleaning compound, or the material may be saturated with a chemical cleaning compound. In an alternative case, a body 104 may include a material that contains an embedded lubricating compound, or may be saturated with a lubricating compound. In another case, interior material of the body 104 may contain an embedded sun protective compound, or may be saturated with a sun protective compound. In general, the body 104 may operably hold a combination of any number of line dressing compounds, such as a cleaning +lubricating compound, or a lubricating+sun protective (“sunscreen”) compound, or may be wetted or saturated with any combination of line dressing compounds. In addition to these dressing compounds, the use of primers, or other curing agents that promote adhesion, bonding, and other chemical stabilization is also contemplated.

With reference still to FIGS. 1-3, line conditioner 100 includes an access port, generally indicated at 108. Access port 108 permits transverse installation of a line into the interior of the body 104. A line may be installed by sliding a length portion of the line through axially oriented slot 112. A bottom of slot 112 terminates at an optional aperture 116. Illustrated aperture 116 extends in a body length direction along centerline 118 between opposite poles of body 104. Slot 112 has an opening disposed on exterior surface 120 of body 104, and extends transversely inward from surface 120. A slot 112 may terminate in proximity to a body centerline 118, or may extend inwardly by more than, or less than, half of the body thickness. Typically, the bottom of the slot 112 is disposed in parallel with the body length centerline 118.

With reference to FIG. 3, an embodiment according to certain principles of the invention may include a body 104 and a waterproof envelope 124 in a configuration packaged for resale. The body 104 may be sealed inside the envelope 124 with the inner body material in a wetted condition. Wetting fluid disposed inside the body 104 may be selected for any desired purpose. A workable envelope 124 may be formed from clear plastic or cellophane sheet, films of various materials including Mylar, and the like.

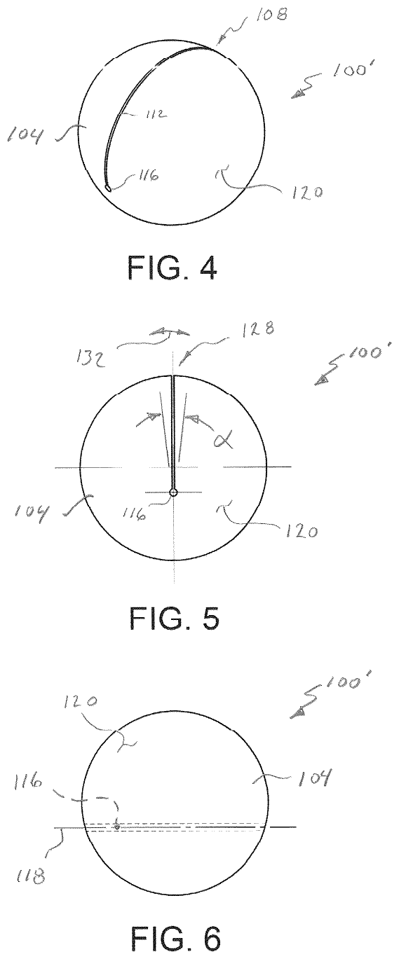

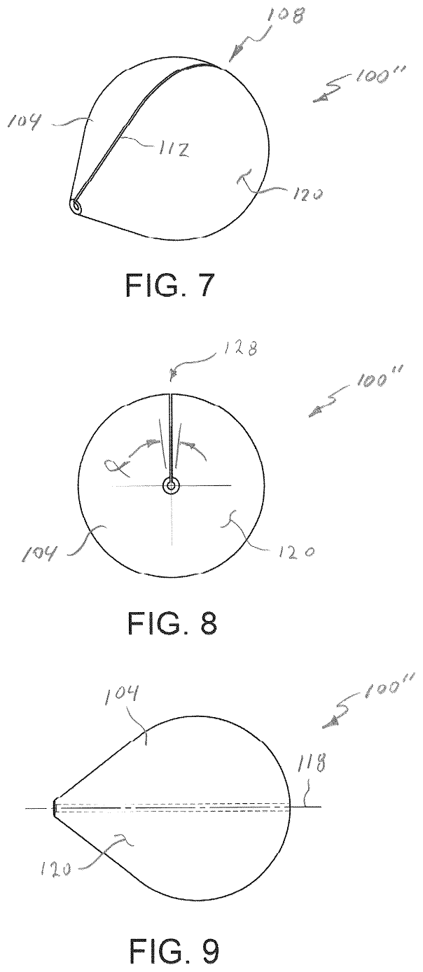

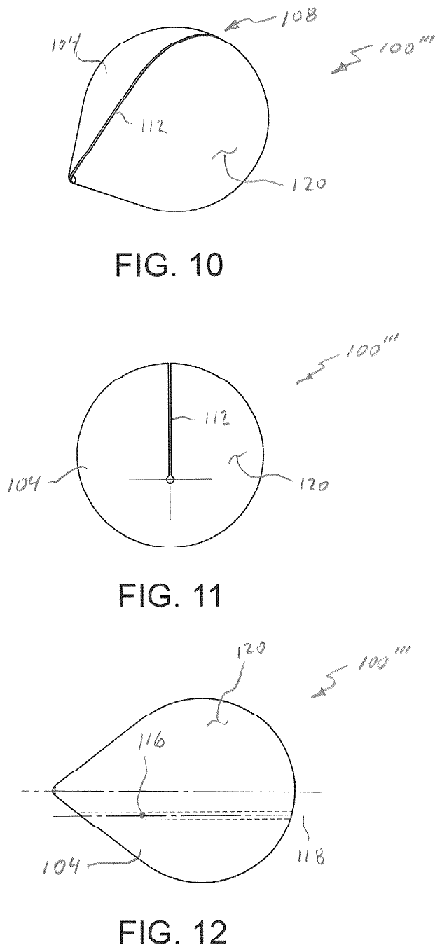

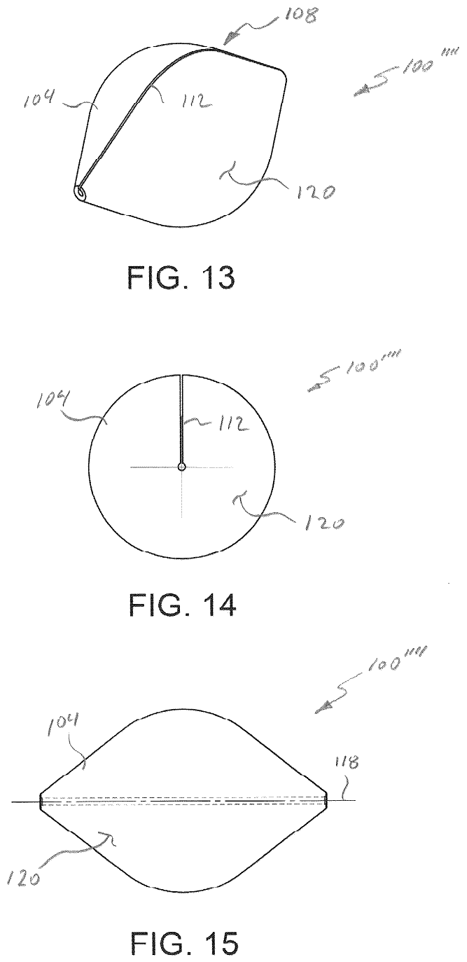

Line conditioners 100′ in FIGS. 4-16 and 100″ in FIGS. 10-12, respectively, have a slot 112 with a depth that is greater than one-half the body thickness. As illustrated in e.g., FIG. 5, the top corners of surface-opening 128 of a workable slot 112 may be pried apart in a spreading direction 132 such that a formed slot opening encompasses an angle α with a vertex associated with the slot bottom. Typically, the body material is consequently biased by the formed opening to urge the slot 112 away from the pried open configuration and toward a closed configuration. Certain slots 112 are biased toward a substantially closed configuration. However, it is within contemplation that certain slots 112 may encompass a small degree of angular opening at an unbiased configuration, such as α less than about 10 degrees. Preferred slots 112 are configured to grip an inserted portion of line to resist decoupling the body 104 from the line under mere weight of the body.

Preferred bodies 104 are configured as 3-dimensional object defined by revolution of a curved line segment about a central body length axis. A preferred line conditioner 100ⁱ may be generally characterized as spheroidal. For non-limiting examples, conditioners 100 and 100′ are generally round. Certain bodies of a conditioner 100ⁱ may be prolate (pointy) at one or both pole ends. For non-limiting examples, conditioners 100″, 100″, and 100″″ include at least one prolate pole. Other 3-dimensional body shapes may be workable in particular cases.

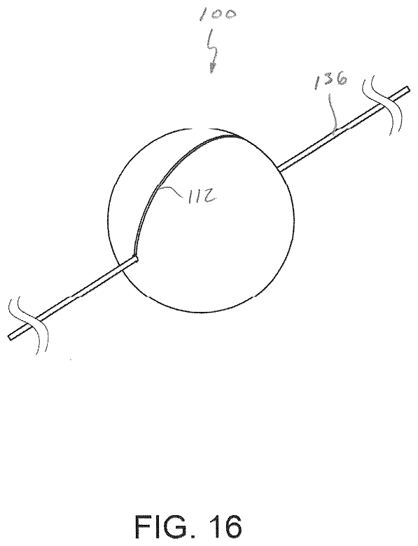

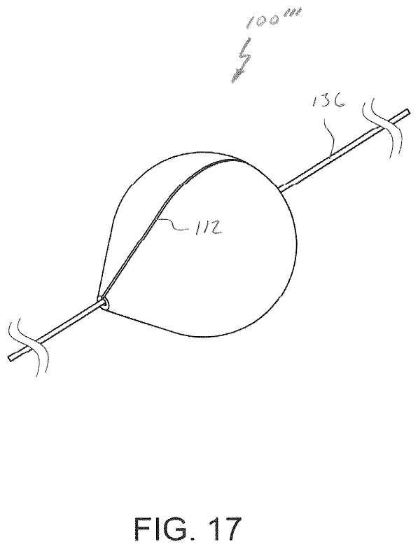

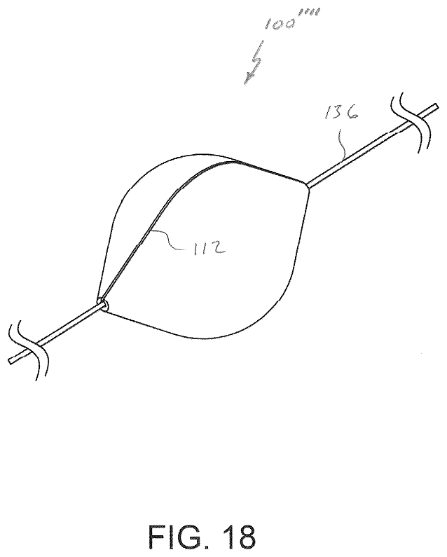

FIGS. 16 through 18 illustrate line conditioners 100ⁱ in an installed position with respect to a line 136. A representative line 136 may be a flyline. In each illustrated case, the line 136 has been passed transversely through a respective slot 112 (e.g., transversely with respect to a centerline of a body 104) for engagement of inner body material in contact with the exterior surface of the line 136. As illustrated, the installed conditioner 100ⁱ remains in association with the line 136 under the weight of the conditioner 100ⁱ.

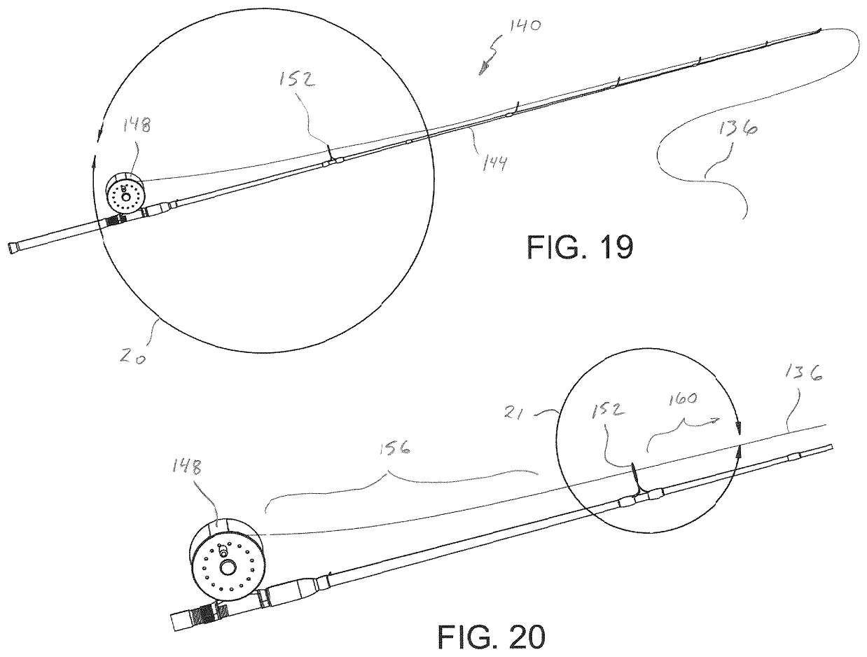

FIGS. 19 and 20 illustrate elements of a fly rod assembly, generally 140, that is relevant to an application of the instant invention. Fly rod assembly 140 includes a rod 144 and a reel 148 to hold a length of line 136. Line 136 passes through stripping guide, or eyelet, 152. A portion of line 136 is disposed inboard of eyelet 152, as indicated at 156. A portion of line 136 is disposed outboard of eyelet 152, as indicated at 160.

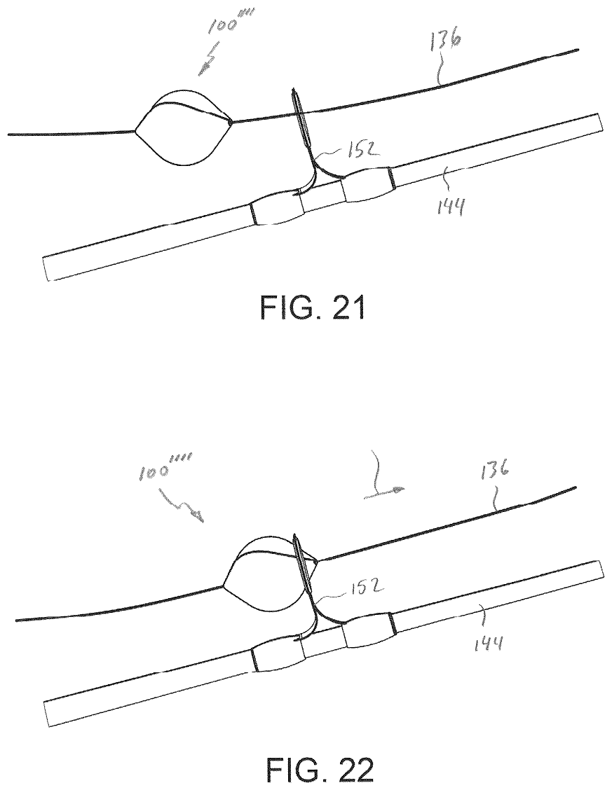

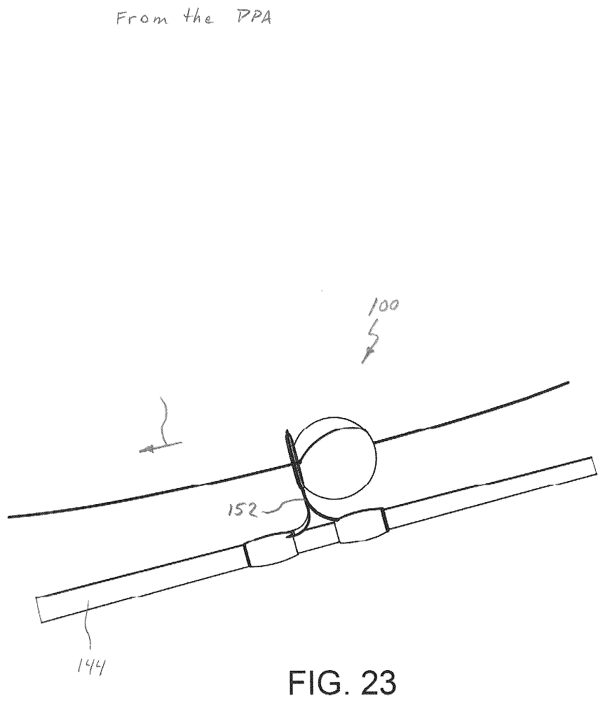

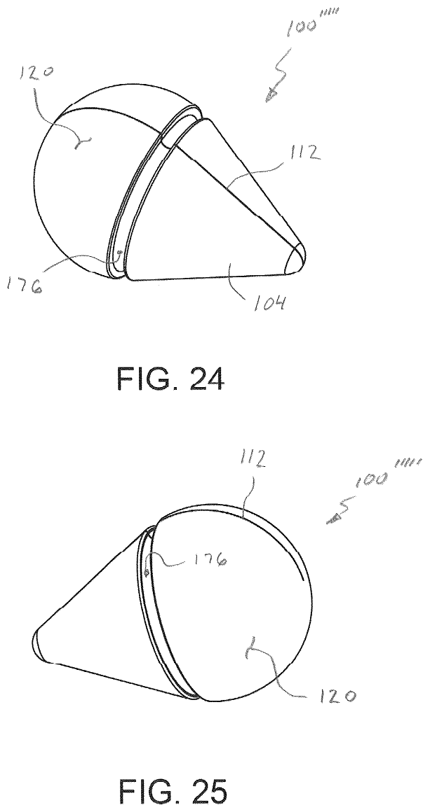

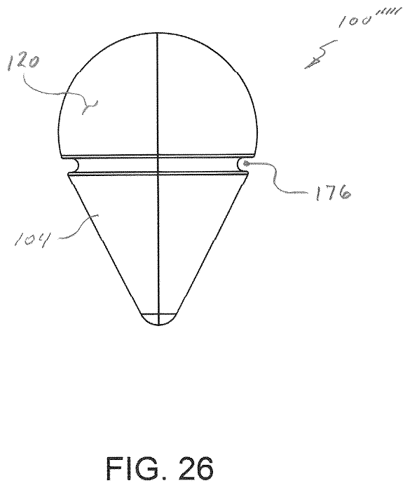

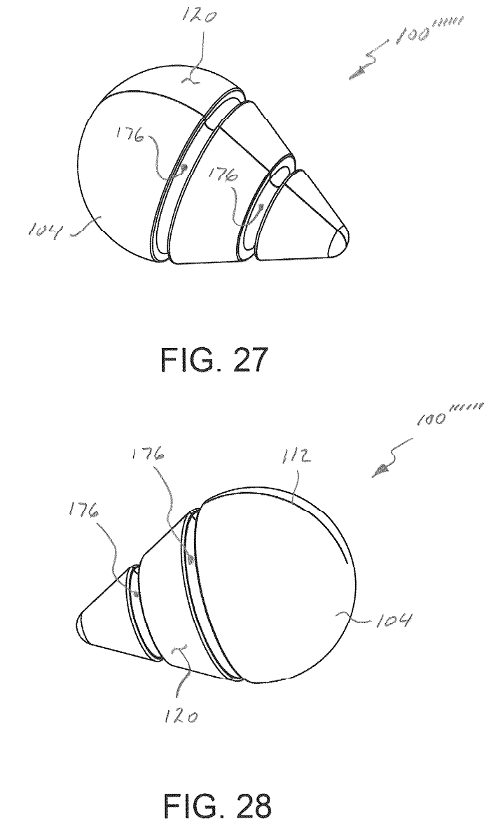

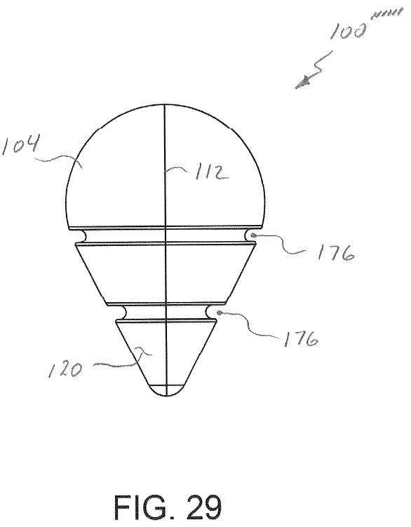

With additional reference to FIGS. 21-23, a user may install a body 104 onto a flyline 136 by transversely sliding an axial portion of the flyline into engagement inside the slot 112 such that the body 104 is disposed in proximity to an eyelet 152 of a fishing pole 144. Desirably, an interface formed between the installed slot 112 and flyline 136 is effective to resist decoupling the body 104 from the flyline 136 under mere weight of the installed body 104. If the body 102 is installed in the inboard length of line 156, the user may then pull an extended length of line in the distal direction 164 to apply an agent to, or otherwise treat, the line 136. The line conditioner 100ⁱ will promptly form a structural interference with the eyelet 152, and line 136 will then be scrubbed as pulled line 136 passes through the body 112. Conversely, if the body 102 is installed in the outboard length of line 160, the user may pull an extended length of line in the proximal direction 168 to apply an agent to, or otherwise treat, the line 136. Line 136 may be pulled in the proximal direction by winding line 136 onto the reel 148. An embodiment 100ⁱ may be configured for a single-use and discard, or may be embodied for a plurality of uses.

Sometimes, eyelet 152 forms a convenient structural interference sufficient to maintain the body 104 within easy reach. Other times, the body 204 may be variously affixed to, or associated with, the eyelet 152. Certain exemplary embodiments 100″′″, 100″″″ may include one or more groove 176 configured to form an additional structural interference with a ring inherently provided by an eyelet 152. It is within contemplation that a smooth body 104 may simply be crammed into retaining reception inside the ring of an eyelet 152. When a body 104 is sufficiently associated with an eyelet 152, a user may pass the flyline 136 through the body 104 in both proximal and distal directions without manually adjusting registration of a line conditioner 100ⁱ with respect to the fishing pole 144. In any case, insertion of a portion of a body 104 into the eyelet 152 is desirably effective to impose an additional compression between the interior material of the body 104 and the exterior surface of the line 136.

It is intended that the language “slot” in a body distinguishes over adjacent surfaces of a folded-over element. By way of illustration, a slot 112 in any illustrated body 104 (e.g., see FIG. 1) is clearly different from a potential spacing between adjacent surfaces of a folded-in-half sheet of paper. The above illustration is believed worth 1,000 words, and the goal is to keep this disclosure relatively succinct.

While aspects of the invention have been described in particular with reference to certain illustrated embodiments, such is not intended to limit the scope of the invention. The present invention may be embodied in other specific forms without departing from its spirit or essential characteristics. For one example, one or more element may be extracted from one described or illustrated embodiment and used separately or in combination with one or more element extracted from one or more other described or illustrated embodiment(s), or in combination with other known structure. The described embodiments are to be considered as illustrative and not restrictive. Obvious changes within the capability of one of ordinary skill are encompassed within the present invention. All changes which come within the meaning and range of equivalency of the claims are to be embraced within their scope.

What is claimed is:

1. An apparatus, comprising:
a body comprising internally disposed body material capable of holding a quantity of fluid for dispensing the fluid onto a desired surface by way of contact between the body material and the surface; and
a line access port configured to permit transverse installation of the body in operable engagement with a flyline to dispose a surface of the flyline in contact with the internally disposed body material.

2. The apparatus according to claim 1, wherein:
the line access port comprises a slot extending transversely inward from a body surface to terminate in proximity to a body centerline.

3. The apparatus according to claim 1, wherein:
the line access port comprises a slot extending transversely inward from a body surface by a distance greater than half a body thickness.

4. The apparatus according to claim 1, wherein:
the line access port comprises a slot extending transversely inward from an opening disposed at a body exterior surface, a bottom of the slot being generally parallel to a body length axis.

5. The apparatus according to claim 4, wherein:
the slot is biased by the body toward a normally-closed position.

6. The apparatus according to claim 4, wherein:
the slot is biased by the body away from an open position in which the opening of the slot encompasses more than about ten degrees about a body centerline.

7. The apparatus according to claim 4, further comprising:
an aperture disposed at a bottom termination of the slot, the aperture defining a path extending through the body in a length direction from a first pole end to an opposite pole end.

8. The apparatus according to claim 1, wherein:
an exterior surface of the body defines a generally spheroid shape.

9. The apparatus according to claim 1, wherein:
an exterior surface of the body defines a generally prolate spheroid shape.

10. The apparatus according to claim 1, wherein:
an exterior surface of the body defines a prolate spheroid shape at one pole end and a generally spheroid shape at an opposite pole end.

11. The apparatus according to claim 4, wherein:
the body is configured to grip a line to hold the weight of the apparatus for hands-free use of the apparatus subsequent to disposing the line in the slot.

12. The apparatus according to claim 11, wherein:
a portion of the exterior surface is configured to engage within a ring provided by an eyelet of a fishing pole such that a structural interference between the body and the ring is operable to hold the body stationary with respect to the fishing pole while moving a length of line in a first direction along a path through the body.

13. The apparatus according to claim 12, wherein:
the body is configured such that insertion of the body into engagement with the eyelet enhances a compression force between the body and a length of line disposed inside the body.

14. The apparatus according to claim 12, wherein;
the body is configured such that the interference is operable to also permit moving the line in a second direction reversed from the first direction.

15. The apparatus according to claim 12, wherein:
the exterior surface comprises a groove adapted to receive the ring to generate the interference.

16. The apparatus according to claim 1, wherein:
the body is an object defined by revolution of a curved line segment about a central body length axis; and
a body exterior surface comprises a circumferentially disposed groove.

17. The apparatus according to claim 1, further comprising:
a waterproof envelope; and
the apparatus is sealed inside the envelope with the body material in a wetted condition by treatment fluid.

18. A method, comprising the steps of:
providing a line conditioner having a body comprising internally disposed body material capable of holding a quantity of fluid for dispensing the fluid onto a desired surface by way of contact between the body material and the surface, and an axially oriented slot extending transversely inward from a body surface to terminate in parallel with a body centerline; and
instructing a user to:
install the body on a flyline by transversely sliding an axial portion of the flyline into engagement inside the slot such that the body is disposed in proximity to an eyelet of a fishing pole, and an interface formed between the slot and flyline is effective to resist decoupling the body from the flyline under weight of the installed body; and
pass an extended length of the flyline in a first length direction through the body while the body applies fluid to, and exerts a compression force on, an exterior surface of the flyline.

19. The method according to claim 18, further comprising:
instructing the user to:
pass the flyline in a second length direction through the body without adjusting registration of the line conditioner with respect to the fishing pole, the second length direction being opposite to the first direction.

20. The method according to claim 18, further comprising:
instructing the user to:
insert the body in partial penetration through the eyelet to engage the eyelet in registration inside a groove disposed in a surface of the body and thereby enhance compression of a portion of internally disposed body material against the flyline.
